(19) United States
(12) Patent Application Publication
(10) Pub. No.: US 2015/0014013 A1
(43) Pub. Date: Jan. 15, 2015

(54) Electrically Operable Machine Tool

(71) Applicant: Robert Bosch GmbH, Stuttgart (DE)

(72) Inventors: Cornelius Boeck, Kirchheim (DE); Daniel Barth, Leinfelden-Echterdingen (DE); Joachim Schadow, Stuttgart (DE); Sinisa Andrasic, Schoenaich (DE)

(21) Appl. No.: 14/368,094

(22) PCT Filed: Nov. 12, 2012
(86) PCT No.: PCT/EP2012/072367

§ 371 Date: Jun. 23, 2014

(30) Foreign Application Priority Data
Dec. 23, 2011 (DE) 10 2011 089 719.4

(51) Int. Cl. B25F 5/02; B24B 23/02

(52) U.S. Cl. CPC B25F 5/02; B24B 23/02
USPC 173/170

(57) ABSTRACT

An electrically operable machine tool, in particular an electrically operable angle grinder, includes at least one handle housing, and at least one switching unit. The at least one switching unit has at least one operating element mounted on one side of the at least one handle housing which faces a palm surface of a user's hand when the handle housing is gripped for proper manipulation.

### PRIOR ART

Already known from DE 197 07 215 A1 is an electrically operable power tool, in particular an angle grinder, which comprises a handle housing and a switching unit that has an operating element, mounted on one side, for actuating a switching element.

### DISCLOSURE OF THE INVENTION

The invention is based on an electrically operable power tool, in particular an electrically operable angle grinder, comprising at least one handle housing, and comprising at least one switching unit, which has at least one operating element mounted on one side.

It is proposed that the operating element be arranged on a side of the handle housing that faces toward an inner surface of an operator's hand, when the handle housing is gripped for proper manipulation. An “electrically operable power tool” is to be understood here to mean, in particular, a power tool having at least one drive unit that can be operated by means of electrical energy. The electrically operable power tool is preferably realized as a portable power tool, in particular as a portable, hand-held power tool. A “portable power tool” is to be understood here to mean, in particular, a power tool for performing work on workpieces, that can be transported by an operator without the use of a transport machine. The portable power tool has, in particular, a mass of less than 40 kg, preferably less than 10 kg, and particularly preferably less than 7 kg. Particularly preferably, the portable power tool is realized as an angle grinder. It is also conceivable, however, for the portable power tool to be of a different design, considered appropriate by persons skilled in the art, such as, for example, designed as a hammer drill and/or chipping hammer, power drill, saber saw, compass saw, hedge shears, etc.

A “handle housing” is to be understood here to mean, in particular, at least one housing or at least one housing sub-region that, to a very large extent, is dissociated from a mounting of a drive unit and/or output unit of the power tool, wherein at least one grip region of the housing or of the housing sub-region, in particular a housing sub-region realized as a stem-type grip region, can be gripped by an operator, by at least one hand, at least to a very large extent, for the purpose of manipulating the power tool. The expression “can be gripped to a very large extent” is intended here to define, in particular, a capability whereby a component or a component region can be gripped by a hand of an operator along at least more than 70%, preferably more than 80%, and particularly preferably more than 90% of a total extent of a total outer circumference of the component or of the component region that runs in a plane extending at least substantially perpendicularly in relation to a direction of longitudinal extent of the component or of the component region, wherein the total extent of the total circumference is, in particular, less than 40 cm, preferably less than 30 cm, and particularly preferably less than 25 cm. Preferably, when the component or component region is gripped, an inner hand surface and inner finger surfaces of the operator's hand are in contact with the total outer circumference at least along a distance greater than 70%, preferably greater than 80%, and particularly preferably greater than 90% of the total extent of the total outer circumference. Preferably, the handle housing is realized so as to be separate from a drive housing of the power tool that is provided to accommodate the drive unit and/or output unit, in order to support drive bearing forces and/or output bearing forces. It is also conceivable, however, for the handle housing and the drive housing to be realized as a single piece. Preferably, the handle housing has a stem-type grip region. The expression “stem-type grip region” is intended here to define, in particular, a housing sub-region of the handle housing that, as viewed in a longitudinal sectional plane, in which the direction of main extent of the power tool extends, along a direction running at least substantially perpendicularly in relation to the direction of main extent, has a maximum extent, in particular, of less than 10 cm, preferably of less than 8 cm, and particularly preferably of less than 6 cm, wherein at least one operating surface of the handle housing is arranged in the housing sub-region of the handle housing. Preferably, the maximum extent, as viewed in the longitudinal sectional plane, is delimited by at least two parallel straight lines, or by at least two straight lines, inclined relative to each other by an angle of less than 10°, preferably of less than 8°, and particularly preferably of less than 6°, that are constituted by an outer contour of the housing sub-region of the handle housing. The stem-type grip region is inclined relative to a direction of main extent of the power tool, in particular, at least by an angle of less than 60°, preferably of less than 40°, and particularly preferably of less than 30°. Preferably, the operating element is arranged on the stem-type grip region of the handle housing. Preferably, the stem-type grip region, as viewed along a rotation axis of a drive element, in particular of an armature shaft, a drive unit of the power tool, and in particular along the direction of main extent of the power tool, is arranged behind the drive unit.

Moreover, it is conceivable for the handle housing, in addition to having the stem-type grip region, to have a bow-shaped sub-region, which is integrally formed on to the stem-type grip region. The bow-shaped sub-region may preferably be of an L-shaped design, which extends in an L shape in the direction of the connecting region, out from an end of the stem-type grip region that faces away from the connecting region of the handle housing. Particularly preferably, the handle housing comprises at least two handle housing shell elements, which can be joined to each other in a joint plane. The handle housing thus preferably has a shell-type structure. It is also conceivable, however, for the handle housing to have a pot-type structure.

The term “switching unit” is intended there to define, in particular, a unit having at least one component, in particular the operating element, which can be actuated directly by an operator, and which is provided to influence and/or alter a process and/or a state of a unit coupled to the switching unit, through an actuation and/or through an input of parameters. The operating element is preferably provided for actuating at least one switching element of the switching unit. Particularly preferably, the operating element is realized as a latch element. A “latch element” is to be understood here to mean, in particular, an operating element that, along a direction of longitudinal extent of the operating element, has a longitudinal extent that is greater than a transverse extent of the operating element that runs at least substantially perpendicularly in relation to the direction of longitudinal extent and runs at least substantially transversely in relation to a main direction of movement of the operating element. “Substantially transversely” is to be understood here to mean, in particular, an alignment of a direction and/or of an axis relative to a reference direction and/or to a reference axis, wherein the alignment of the direction and/or of the axis are at least different from an at least substantially parallel alignment in relation to the reference direction and/or to the reference axis and, in particular, are askew or at least substantially perpendicular in relation to the reference direction and/or to the reference axis. Preferably, a maximum longitudinal extent of the latch element is at least 2 times greater, preferably at least 4 times greater, and particularly preferably at least 6 times greater than a maximum transverse extent of the latch element. The latch element has, in particular, a maximum longitudinal extent that is greater than 3 cm, preferably greater than 6 cm, and particularly preferably greater than 8 cm. In addition, the latch element preferably comprises an operating surface on which an operator can place at least three fingers in order to actuate the latch element, and which has, at least, running along the direction of longitudinal extent of the latch element, a longitudinal extent that is greater than 5 cm.

The expression “substantially perpendicularly” is intended here to define, in particular, an alignment of a direction relative to a reference direction, wherein the direction and the reference direction, in particular as viewed in one plane, enclose an angle of 90° and the angle has a maximum deviation of, in particular, less than 8°, advantageously less than 5°, and particularly advantageously less than 2°.

Preferably, the switching unit is provided to actuate the switching element by means of an actuation of the operating element, in order to open or close an electric circuit for supplying energy, at least to a drive unit of the power tool. The switching unit is thus preferably provided to enable the power tool to be put into operation or deactivated. “Provided” is to be understood to mean, in particular, specially designed and/or specially equipped. The switching element is preferably constituted by a mechanical, electrical and/or electronic switching element.

The expression “mounted on one side” is intended here to define, in particular, an arrangement of a bearing axis of a component, in particular of the operating element, whereby the bearing axis is arranged at least at one end or at an edge region of an operating surface of the component, and, in particular, if the course of the bearing axis is through the component, is at a distance from the end of the component or from the edge region of the operating surface, that is less than 30 mm, preferably less than 20 mm, and particularly preferably less than 10 mm, as viewed along a direction of longitudinal extent of the component, wherein the longitudinal axis is preferably different from a central bearing axis that, as viewed along a direction running at least substantially perpendicularly in relation to the bearing axis, is at equal distances from two ends of the component that face away from each other. It is also conceivable, however, for the bearing axis to run outside of the component, and for the component to be mounted so as to be movable about and/or along the bearing axis, by means of bearing elements, such as, for example, lever bearing elements, that are arranged, in particular arranged in a movable manner, on the component. Moreover, it is also conceivable for the operating element to be mounted on a plurality of sides, such as, for example, in the case of a translationally guided operating element that is guided on two sides, facing away from each other, in guide elements of a translational guide unit. Other arrangements of a bearing axis, or of a plurality of bearing axes of the operating element, considered appropriate by persons skilled in the art, are likewise conceivable. The term “inner hand surface” is intended here to define, in particular, a central hand joint surface of an operator's hand, wherein, in particular, the central hand joint surface is different from inner finger surfaces. Advantageously, with the electrically operable power tool designed according to the invention, it is possible to achieve a high degree of operating comfort. In this case, advantageously, the operating element can be actuated comfortably by means of an inner hand surface, owing to the fact that the operating element is arranged on the side of the handle housing that faces toward an inner surface of an operator's hand, when the handle housing is gripped for proper manipulation. Force can thus be applied to the operating element, over a large surface, in a comfortable manner.

Furthermore, it is proposed that the electrically operable power tool comprise at least one output housing, wherein the operating element, in each operating state, is arranged on a side of the handle housing that is different from a further side of the handle housing that faces toward an output side of the output housing. An “output side” is to be understood here to mean, in particular, a side of the electrically operable power tool from which a spindle of the output unit extends out of the output housing of the electrically operable power tool. Advantageously, it can be ensured that the operating element, in each operating state of the electrically operable power tool according to the invention, can be actuated comfortably by means of an inner hand surface of an operator's hand. In particular, advantageously, it is possible to achieve comfortable operation of an electrically operable power tool having an output housing that is mounted so as to be rotatable relative to a drive housing of the electrically operable power tool.

Advantageously, the operating element is mounted so as to be pivotable about a pivot axis that is arranged outside of an operating surface region of the operating element. An “operating surface region” is to be understood here to mean, in particular, a region of the operating element that, as viewed along a direction of longitudinal extent or along a that is at least substantially transverse in relation to a main direction of movement of the operating element, is delimited by at least two planes that are spaced apart relative to each other, and in which at least one operating surface, which can be contacted directly by an operator for the purpose of actuating the operating element, is arranged in its entirety. The pivot axis, as viewed along a direction of longitudinal extent of the operating element, can thus be arranged laterally next to the operating surface region, in front of or behind the operating surface region. Advantageously, a lever ratio can be used to render the operating element comfortable to operate, so that only a small actuating force and a small holding force are required for actuating and holding the operating element.

Particularly preferably, the pivot axis, as viewed along a direction of longitudinal extent of the operating element, is spaced apart relative to an operating surface of the operating element. In this case, the pivot axis, as viewed along a direction of longitudinal extent of the operating element, can be arranged in front of or behind the operating surface. Particularly preferably, the pivot axis of the operating element runs at least substantially perpendicularly in relation to the joint plane of the handle housing, in which the handle housing shell elements can be joined to each other, or are in contact with each other. By means of the design according to the invention, it is advantageously possible to achieve a compact arrangement of the operating element on the handle housing.

Advantageously, the pivot axis is arranged at an end of the operating element that faces toward a connecting region of the handle housing. The expression “connecting region” is to be understood here to mean, in particular, a region of the handle housing via which the handle housing is connected to the drive housing in a form closed, force closed and/or materially bonded manner, or by means of which the handle housing is in direct contact with the drive housing. An “end of the operating element that faces toward the connecting region” is to be understood here to mean, in particular, an arrangement of points of the operating element, in respect of a central plane of the operating element, that runs at least substantially perpendicularly in relation to the direction of longitudinal extent of the operating element, and that is arranged at least substantially equally from two ends of the operating element that are spaced apart from each other along the direction of longitudinal extent of the operating element, wherein all points of the operating element, that are arranged, out from the central plane, in the direction of the connecting region, as viewed along the direction of longitudinal extent of the operating element, are considered to face toward the connecting region. Advantageously, it is possible to achieve ergonomic operation of the operating element. An operator can actuate the operating element particularly comfortably when gripping the handle housing by means of an inner hand surface of the operator's hand.

In an alternative design of the electrically operable power tool, the pivot axis is arranged at an end of the operating element that faces away from a connecting region of the handle housing. This, likewise, makes it possible to achieve ergonomic operation of the operating element. Moreover, advantageously, the pivotable mounting is to a very large extent insusceptible to accumulation of dirt at a bearing point.

In a further alternative design of the electrically operable power tool, the operating element is mounted in a translationally movable manner. In this case, a movement axis of the operating element preferably runs at least substantially parallelwise in relation to the joint plane of the handle housing. Advantageously, it is possible to achieve exact guidance of the operating element during an actuation.

Particularly preferably, a movement axis of the operating element runs at least substantially transversely in relation to a direction of longitudinal extent of the handle housing. Particularly preferably, if the operating element is mounted translationally, the movement axis runs in the joint plane of the handle housing. Preferably, if the operating element is pivotally mounted, the movement axis runs at least substantially perpendicularly in relation to the joint plane of the handle housing. It is thus advantageously possible to achieve a main direction of movement of the operating element that extends in the joint plane of the handle housing.

It is additionally proposed that, after an actuation, an operating surface of the operating element be at least substantially flush with an outer surface of the handle housing. “At least substantially flush with” is to be understood here to mean, in particular, an arrangement of the operating surface, after an actuation of the operating element, in particular after the operating element has been pivoted into the handle housing, wherein the operating surface, as viewed out from a space enclosed by the handle housing, in the direction of the outer surface of the handle housing, along a direction running at least substantially perpendicularly in relation to the outer surface of the handle housing, extends maximally 2 mm over the outer surface, and particularly preferably extends maximally as far as the outer surface of the handle housing. The operating surface of the operating element, after an actuation, thus does not extend beyond the outer surface of the handle housing. Advantageously, as a result of the operating element being inserted fully into the handle housing, it is possible to achieve a compact arrangement of the operating element when in an actuated state. Moreover, advantageously, an operator can be provided with a visual indication that the operating element is in an actuated state.

Furthermore, it is proposed that the electrically operable power tool comprise at least one switch-on inhibitor unit, which is provided to avoid a movement of the operating element resulting from an unintentional actuation of the operating element. A “switch-on inhibitor unit” is to be understood here to mean, in particular, a unit provided to prevent to a very large extent a movement of a movably mounted component, in particular of the operating element, along at least one distance and/or about at least one axis, at least in an operating state, by means of a mechanical, electrical and/or electronic inhibitor. Preferably, the switch-on inhibitor unit is provided to prevent to a very large extent a movement of the operating element, at least in an operating state, by means of a mechanical inhibitor. It is also conceivable, however, for the switch-on inhibitor unit to prevent to a very large extent a movement of the operating element, at least in an operating state, by means of an electromagnetic action of force and/or a permanent-magnet action of force, such as, for example, by means of displaceable magnets, upon the operating element. Advantageously, by means of the design according to the invention, it is possible, to a very large extent, to prevent the power tool being put into operation unintentionally.

Advantageously, the switch-on inhibitor unit has at least one release element, which comprises an actuating region that is arranged, at least partially, laterally next to an operating surface of the operating element. “Laterally next to” is to be understood here to mean, in particular, an arrangement of the actuating region of the release element relative to the operating element, wherein the actuating region, as viewed along a direction running at least substantially perpendicularly in relation to the side wall region, in particular as viewed out from the side wall region in a direction away from the handle housing, is arranged at a distance relative to the operating element. Advantageously, an ergonomically appropriate arrangement of the release element, in particular of the actuating region, can be achieved.

It is additionally proposed that the operating element have a maximum longitudinal extent that corresponds to at least 60% of a maximum longitudinal extent of a stem-type grip region of the handle housing. In particular, a maximum longitudinal extent of the operating element corresponds, in particular, to more than 75%, preferably to more than 80%, and particularly preferably to more than 90% of the maximum longitudinal extent of the stem-type grip region. When the operating element and the handle housing are in a mounted state, the maximum longitudinal extent of the operating element and the maximum longitudinal extent of the stem-type grip region of the handle housing extend along a direction that runs in the joint plane of the handle housing, in which the handle housing shell elements are in contact with each other, or are joined to each other, when in a mounted state, and that runs at least substantially transversely in relation to the main direction of movement of the operating element. Advantageously, a large usable operating surface of the operating element can be achieved. It is thus advantageously possible to create an operating element that is comfortable to operate.

It is additionally proposed that the operating element have a maximum transverse extent that corresponds to at least 60% of a maximum transverse extent of the stem-type grip region of the handle housing. The expression “maximum transverse extent” is intended there to define, in particular, a maximum extent of a component or of a housing, in particular of a multipart housing, when in a mounted state, along a direction that runs at least substantially perpendicularly in relation to the direction of main extent of the power tool and at least substantially transversely at least in relation to a main direction of movement of the operating element. Preferably, a maximum transverse extent of the operating element corresponds preferably to more than 65%, preferably to more than 70%, and particularly preferably to more than 75% of the maximum transverse extent of the stem-type grip region. Advantageously, with the electrically operable power tool designed according to the invention, it is possible to achieve an ergonomically appropriate design of the operating element. Advantageously, a high degree of operating comfort can thus be achieved.

The invention is additionally based on a power switching device of a power tool according to the invention, wherein the power tool switching device comprises at least the switching unit. In addition, it is conceivable for the power tool switching device to have at least one bearing unit, for mounting the latch element in a movable manner. The bearing unit in this case may be realized as a translational bearing unit, as a rotational bearing unit, or of a combination of a translational bearing unit and a rotational bearing unit, such as, for example, a lever mechanism bearing unit, etc. Thus, advantageously, already existing power tools can easily be retrofitted with the switching unit according to the invention.

The electrically operable power tool according to the invention and/or the power tool switching device according to the invention are/is not intended in this case to be limited to the application and embodiment described above. In particular, the electrically operable power tool according to the invention and/or the power tool switching device according to the invention may have individual elements, components and units that differ in number from a number stated herein, in order to fulfill a principle of function described herein.

### DRAWING

Further advantages are given by the following description of the drawing. The drawing shows exemplary embodiments of the invention. The drawing, the description and the claims contain numerous features in combination. Persons skilled in the art will also expediently consider the features individually and combine them to create appropriate further combinations.

In the drawing:

FIG. 1 shows an electrically operable power tool according to the invention, in a schematic representation,

FIG. 2 shows a detail view of an operating element arranged on a handle housing of the electrically operable power tool according to the invention, in a schematic representation,

FIG. 3 shows a further detail view of the operating element arranged on the handle housing, in a schematic representation,

FIG. 4 shows a detail view of an operating element arranged on a handle housing of an alternative electrically operable power tool according to the invention, in a schematic representation, and

FIG. 5 shows a detail view of an operating element arranged on a handle housing of a further alternative electrically operable power tool according to the invention, in a schematic representation.

### DESCRIPTION OF THE EXEMPLARY EMBODIMENTS

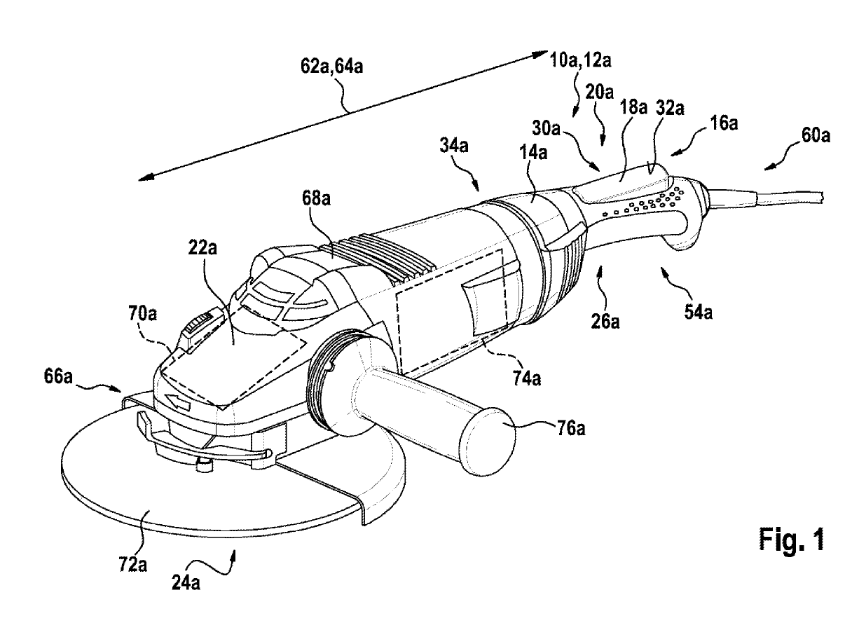

FIG. 1 shows an electrically operable power tool 10a, which is constituted by a portable power tool 10a realized as an electrically operable angle grinder 12a. The portable power tool 10a comprises at least one handle housing 14a, and at least one switching unit 16a, which has at least one operating element 18a mounted on one side. The operating element 18a is arranged on a side 20a of the handle housing 14a that faces toward an inner surface of an operator's hand when the handle housing 14a is gripped for proper manipulation. The portable power tool 10a in this case has at least one power tool switching device, which comprises at least the switching unit 16a. The operating element 18a is arranged on a stem-type grip region 54a of the handle housing 14a. The stem-type grip region 54a of the handle housing 14a constitutes a main handle of the portable power tool 10a. In this case, the main handle constituted by the stem-type grip region 54a extends, at least substantially, out from a connecting region 34a of the handle housing 14a, in a direction away from the connecting region 34a, as far as a side 60a of the main handle housing 14a on which there is arranged a cable of the portable power tool 10a, realized as an electrically operable angle grinder 12a, for supplying energy. The stem-type grip region 54a of the handle housing 14a is offset relative to a direction of main extent 62a of the handle housing 14a, or relative to a direction of main extent 64a of the portable power tool 10a, by an angle of less than 30°.

The portable power tool 10a, realized as an electrically operable angle grinder 12a, additionally comprises a protective hood unit 66a, a drive housing 68a and an output housing 22a. In this case, the operating element 18a, in each operating state of the power tool 10a, is arranged on the side 20a of the handle housing 14a that is different from a further side 26a of the handle housing 14a that faces toward an output side 24a of the output housing 22a. Extending out from the output housing 22a, on the output side 24a of the output housing 22a, there is an output shaft of an output unit 70a of the portable power tool 10a, which is realized as a spindle (not represented in greater detail here), to which a working tool 72a can be fixed, for performing work on a workpiece (not represented in greater detail here). The working tool 72a is realized as an abrasive disk. It is also conceivable, however, for the working tool 72a to be realized as a parting disk or polishing disk. The portable power tool 10a comprises the drive housing 68a, for accommodating a drive unit 74a of the portable power tool 10a, and the output housing 22a, for accommodating the output unit 70a. The drive unit 74a is provided to drive the working tool 72a in rotation, via the output unit 70a. For the purpose of performing work on a workpiece, the working tool 72a in this case may be connected to the spindle in a rotationally fixed manner by means of a fastening element (not represented in greater detail here). The working tool 72a can thus be driven in rotation when the portable power tool 10a is in operation. The output unit 70a is connected to the drive unit 74a via a drive element (not represented in greater detail here) of the drive unit 74a that is realized as a pinion gear and that can be driven in rotation, in a manner already known to persons skilled in the art. In addition, an ancillary handle 76a is arranged on the output housing 22a. When mounted on the output housing 22a, the ancillary handle 76a extends transversely in relation to the direction of main extent 64a of the portable power tool 10a.

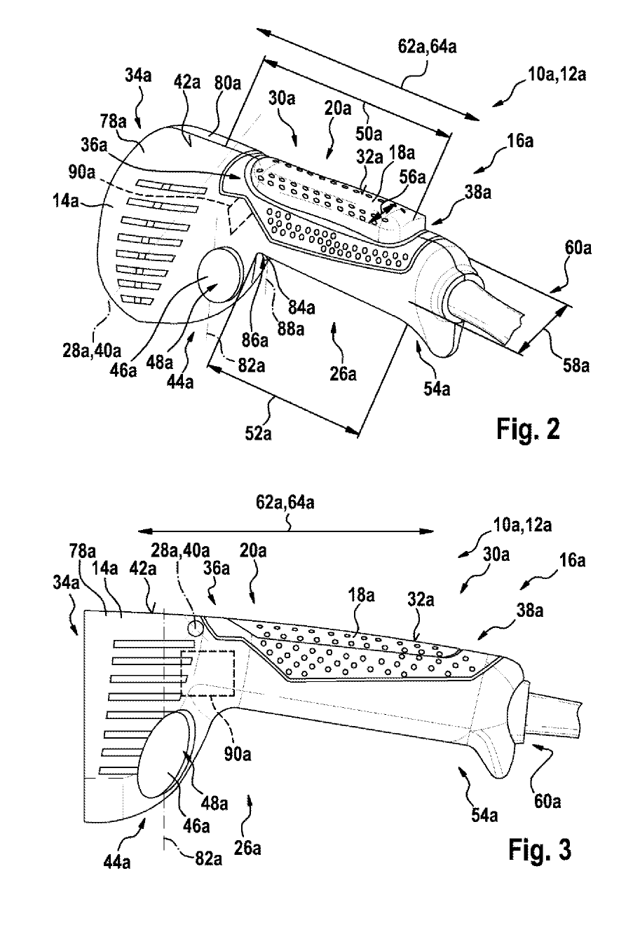

FIG. 2 shows a detail view of the operating element 18a of the switching unit 16a arranged on the handle housing 14a. The operating element 18a has a domed outer contour. In this case, the operating element 18a has a convex outer contour in respect of the handle housing 14a. In addition, the operating element 18a is mounted so as to be pivotable about a pivot axis 28a of the operating element 18a that is arranged outside of an operating surface region 30a of the operating element 18a. The pivot axis 28a of the operating element 18a runs at least substantially perpendicularly in relation to the direction of main extent 62a of the handle housing 14a, or at least substantially perpendicularly in relation to the direction of main extent 64a of the portable power tool 10a. In this case, the pivot axis 28a runs at least substantially perpendicularly in relation to a joint plane of the handle housing 14a. When in a mounted state, two handle housing shell elements 78a, 80a of the handle housing 14a are joined together in the joint plane of the handle housing 14a. The pivot axis 28a is arranged at the end 36a of the operating element 18a that faces toward the connecting region 34a of the handle housing 14a. The operating element 18a is thus pivotally mounted at the end 36a that faces toward the connecting region 34a of the handle housing 14a.

The operating element 18a is mounted so as to be pivotable about the pivot axis 28a that is arranged outside of an operating surface region 30a of the operating element 18a. The pivot axis 28a, as viewed along a direction of longitudinal extent of the operating element 18a, is spaced apart relative to an operating surface 32a of the operating element 18a. The direction of longitudinal extent of the operating element 18a runs in the joint plane of the handle housing 14a. Moreover, a movement axis 40a of the operating element 18a that is realized as the pivot axis 28a runs at least substantially transversely in relation to a direction of longitudinal extent of the handle housing 14a. The direction of longitudinal extent of the handle housing 14a runs at least substantially parallelwise in relation to the direction of main extent 62a of the handle housing 14a, or at least substantially parallelwise in relation to the direction of main extent 64a of the portable power tool 10a. When the operating element 18a is in an unactuated state, the operating surface 32a of the operating element 18a, as viewed along a direction running at least substantially perpendicularly in relation to an outer surface 42a of the handle housing 14a, out from an interior of the handle housing 14a that is enclosed by the handle housing 14a, extends beyond the outer surface 42a, in a direction away from the handle housing 14a. In addition, after an actuation of the operating element 18a, the operating surface 32a of the operating element 18a is, at least partially, at least substantially flush with the outer surface 42a of the handle housing 14a. Thus, as a result of an actuation in the direction of the handle housing 14a, the operating element 18a is pivoted, about the pivot axis 28a, into the handle housing 14a (FIG. 3). The operating surface 32a in this case is one realized convexly in respect of the handle housing 14a. The operating surface 32a is thus realized so as to correspond with the outer surface 42a of the stem-type grip region 54a of the handle housing 14a.

Furthermore, the portable power tool 10a has at least one switch-on inhibitor unit 44a, which is provided to avoid a movement of the operating element 18a resulting from an unintentional actuation of the operating element 18a. The switch-on inhibitor unit 44a has at least one release element 46a, which comprises an actuating region 48a that is arranged, at least partially, laterally next to an operating surface 32a, of the operating element 18a. The release element 46a is arranged on the handle housing 14a, in a region of an end of the handle housing 14a that faces toward the connecting region 34a. In addition, the release element 46a is arranged entirely outside of the stem-type grip region 54a. In this case, at least the actuating region 48a of the release element 46a is arranged outside of the stem-type grip region 54a. The release element 46a is mounted so as to be pivotable about at least one release movement axis 82a. The release movement axis 82a is thus realized as a release pivot axis. The release element 46a has, at least, the release movement axis 82a, which runs in a plane extending at least substantially perpendicularly in relation to a pivot axis 28a of the operating element 18a. The release movement axis 82a thus runs at least substantially parallelwise in relation to the joint plane of the handle housing 14a. Moreover, the release movement axis 82a runs at least substantially transversely in relation to the pivot axis 28a of the operating element 18a.

Furthermore, the switch-on inhibitor unit 44a has at least one further release element 84a. The further release element 84a is likewise arranged on the handle housing 14a, in the region of the end of the handle housing 14a that faces toward the connecting region 34a. Moreover, the further release element 84a is likewise arranged entirely outside of the stem-type grip region 54a. In this case, at least one actuating region 86a of the further release element 84a is arranged outside of the stem-type grip region 54a. The further release element 84a is arranged in a mirror-symmetrical manner in relation to the release element 46a. The further release element 84a thus has, at least, the actuating region 86a, which, in respect of a plane extending at least substantially perpendicularly in relation to the pivot axis 28a of the operating element 18a, is arranged, at least partially, laterally next to the operating surface 32a of the operating element 18a, in a mirror-symmetrical manner in relation to the actuating region 48a of the release element 46a. The further release element 84a is mounted so as to be pivotable about at least one further release movement axis 88a. It is also conceivable, however, for the release element 46a and the further release element 84a to be mounted so as to be translationally movable on the handle housing 14a. The further release movement axis 88a is realized as a release pivot axis. The further release movement axis 88a in this case runs in a plane extending at least substantially perpendicularly in relation to the pivot axis 28a of the operating element 18a. The further release movement axis 88a thus runs at least substantially parallelwise in relation to the joint plane of the handle housing 14a. Moreover, the release movement axis 88a runs at least substantially transversely in relation to the pivot axis 28a of the operating element 18a. The further release movement axis 88a runs at least substantially parallelwise in relation to the release movement axis 82a of the release element 46a. The release element 46a and the further release element 84a are mounted so as to be movable relative to each other. It is also conceivable, however, for the release element 46a and the further release element 84a to be rigidly coupled to each other.

In addition, the portable power tool 10a has at least one movement dependence unit 90a, which motionally couples the release element 46a and the further release element 84a to each other, at least when in a mounted state. The movement dependence unit 90a is provided to move the release element 46a and the further release element 84a in opposite directions as a result of an actuation of the release element 46a or of the further release element 84a. The release element 46a and the further release element 84a are thus always moved jointly, by means of the movement dependence unit 90a, as a result of an actuation of the release element 46a or of the further release element 84a. In this case, the release element 46a and the further release element 84a are moved in a direction toward the handle housing 14a, as a result of an actuation of the release element 46a or of the further release element 84a in a direction toward the handle housing 14a, by means of the movement dependence unit 90a. As a result of an actuation of the release element 46a or of the further release element 84a, forces are transmitted between the release element 46a and the further release element 84a, by means of the movement dependence unit 90a, which forces cause the release element 46a and the further release element 84a to move in dependence on each other.

In an alternative design of the portable power tool 10a, which is not represented in greater detail here, it is conceivable for the portable power tool 10a, in addition to having the switch-on inhibitor unit 44a, to have an electrical and/or electronic start-up inhibitor, which, for example, only allows the drive unit 74a to be supplied with electric power once a sensor unit of the portable power tool 10a senses a further hand of an operator being in contact with the ancillary handle 76a, in addition to a hand being in contact with the handle housing 14a, in particular with the stem-type grip region 54a, and thus deactivates the electrical and/or electronic start-up inhibitor, via an open-loop and/or closed-loop control unit of the portable power tool 10a, which evaluates and processes the sensed characteristic quantities, to enable the portable power tool 10a to be put into operation.

Furthermore, the switching unit 16a has a spring element (not represented in greater detail here) for constituting a dead man's circuit function. The spring element is provided to enable the operating element 18a to move into an initial position of the operating element 18a, as a result of an action of a spring force upon the operating element 18a, after removal of an action of an actuating force of an operator upon the operating element 18a, in a direction away from the handle housing 14a. In this case, the spring element is constituted by a spring element of the switching element that applies a spring force to a switching tappet of the switching element (not represented in greater detail here). The spring element thus exerts a spring force upon the operating element. As a result of this, the operating element 18a, after removal of an action of an actuating force of an operator, is moved in the direction away from the handle housing 14a. As a result of the movement of the operating element 18a in the direction away from the handle housing 14a, the operating element 18a is moved into an initial position.

The operating element 18a has a maximum transverse extent 56a that extends at least over a major part of at least one maximum transverse extent 58a of the stem-type grip region 54a of the handle housing 14a. The maximum transverse extent 56a of the operating element 18a corresponds to at least 60% of the maximum transverse extent 58a of the stem-type grip region 54a of the handle housing 14a. In this case, a ratio of the maximum transverse extent 56a of the operating element 18a to the maximum transverse extent 58a of the stem-type grip region 54a of the handle housing 14a is at least greater than 1 to 2.5. The maximum transverse extent 56a of the operating element 18a runs along a direction that runs at least substantially perpendicularly in relation to the direction of main extent 62a of the handle housing 14a, or at least substantially perpendicularly in relation to the direction of main extent 64a of the portable power tool 10a, and at least substantially transversely at least in relation to a main direction of movement of the operating element 18a. The maximum transverse extent 56a of the operating element 18a thus runs at least substantially parallelwise in relation to the pivot axis 28a of the operating element 18a. The maximum transverse extent 58a of the stem-type grip region 54a of the handle housing 14a likewise runs along the direction that runs at least substantially perpendicularly in relation to the direction of main extent 62a of the handle housing 14a, or at least substantially perpendicularly in relation to the direction of main extent 64a of the portable power tool 10a, and at least substantially transversely at least in relation to a main direction of movement of the operating element 18a.

Furthermore, the operating element 18a has a maximum longitudinal extent 50a that extends at least over a major part of a maximum longitudinal extent 52a of the stem-type grip region 54a of the handle housing 14a. In this case, the maximum longitudinal extent 50a of the operating element 18a corresponds to at least 60% of the maximum longitudinal extent 52a of the stem-type grip region 54a of the handle housing 14a. A ratio of the maximum longitudinal extent 50a of the operating element 18a to the maximum longitudinal extent 52a of the stem-type grip region 54a of the handle housing 14a is at least greater than 1 to 1.4. When the operating element 18a has been mounted on the handle housing 14a, the maximum longitudinal extent 50a of the operating element 18a extends along a direction that runs in the joint plane of the handle housing 14a, and that runs at least substantially transversely in relation to a main direction of movement of the operating element 18a. The maximum longitudinal extent 50a of the operating element 18a thus extends along a direction that runs at least substantially perpendicularly in relation to the pivot axis 28a of the operating element 18a. In addition, the maximum longitudinal extent 50a of the operating element 18a, out from a bearing region (not represented in greater detail here) of the operating element 18a that is arranged in the handle housing 14a, through which the pivot axis 28a of the operating element 18a runs, is as far as the end 38a of the operating element 18a that faces away from the connecting region 34a of the handle housing 14a (FIG. 2). The maximum longitudinal extent 52a of the stem-type grip region 54a of the handle housing 14a likewise extends along the direction that runs at least substantially perpendicularly in relation to the pivot axis 28a of the operating element 18a.

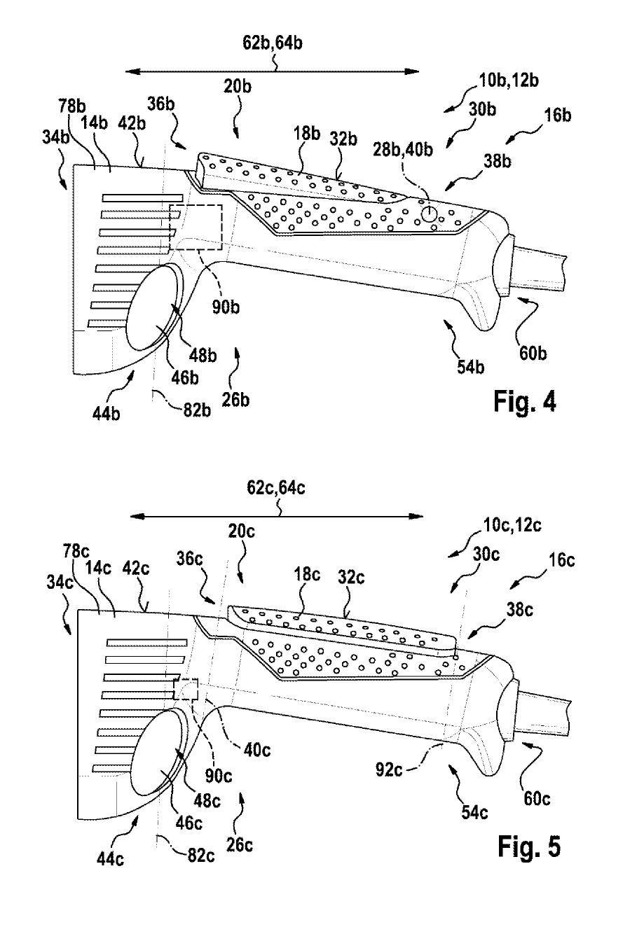

Alternative exemplary embodiments are represented in FIGS. 4 and 5. Components, features and functions that remain substantially the same are denoted, in principle, by the same references. To differentiate the exemplary embodiments, the letters a to c have been appended to the references of the exemplary embodiments. The description that follows is limited substantially to the differences in relation to the first exemplary embodiment in FIGS. 1 to 3, and reference may be made to the description of the first exemplary embodiment in FIGS. 1 to 3 in respect of components, features and functions that remain the same.

FIG. 4 shows a detail view of an operating element 18a of a switching unit 16b of an electrically operable power tool 10b, arranged on a handle housing 14b of the electrically operable power tool 10b. The electrically operable power tool 10b has a structure that is at least substantially similar to that of the electrically operable power tool 10a from FIG. 1. Reference may therefore be made, at least substantially, to the description of FIG. 1 in respect of a description, or features, of the electrically operable power tool 10b of the further exemplary embodiment. The electrically operable power tool 10b is likewise realized as a portable power tool 10b, which is constituted by an electrically operable angle grinder 12b.

The operating element 18b is arranged on a side 20b of the handle housing 14b that faces toward an inner surface of an operator's hand when the handle housing 14b is gripped for proper manipulation. In this case, the operating element 18b of the switching unit 16b is mounted so as to be pivotable about a pivot axis 28b of the operating element 18b that is arranged outside of an operating surface region 30b of the operating element 18b. The pivot axis 28b of the operating element 18b runs at least substantially perpendicularly in relation to a direction of main extent 62b of the handle housing 14b, or at least substantially perpendicularly in relation to a direction of main extent 64b of the portable power tool 10b. In this case, the pivot axis 28b runs at least substantially perpendicularly in relation to a joint plane of the handle housing 14b. The pivot axis 28b is arranged at an end 38b of the operating element 18b that faces away from a connecting region 34b of the handle housing 14b. The operating element 18b is thus pivotally mounted at the end 38b that faces away from the connecting region 34b of the handle housing 14b. In this case, the operating element 18b is mounted so as to be pivotable about the pivot axis 28b that is arranged outside of an operating surface region 30b of the operating element 18b. The pivot axis 28b, as viewed along a direction of longitudinal extent of the operating element 18b, is spaced apart relative to an operating surface 32b of the operating element 18b. The direction of longitudinal extent of the operating element 18b runs in the joint plane of the handle housing 14b. Moreover, a movement axis 40b of the operating element 18b that is realized as the pivot axis 28b runs at least substantially transversely in relation to a direction of longitudinal extent of the handle housing 14b. When the operating element 18b is in an unactuated state, an operating surface 32b of the operating element 18b, as viewed along a direction that is at least substantially perpendicular to an outer surface 42b of the handle housing 14b, out from an interior of the handle housing 14b that is enclosed by the handle housing 14b, extends beyond the outer surface 42b, in a direction away from the handle housing 14b. In addition, after an actuation of the operating element 18b, the operating surface 32b of the operating element 18b is, at least partially, at least substantially flush with the outer surface 42b of the handle housing 14b. Thus, as a result of an actuation in the direction of the handle housing 14b, the operating element 18b is pivoted, about the pivot axis 28b, into the handle housing 14b.

FIG. 5 shows a detail view of an operating element 18c of a switching unit 16c of an electrically operable power tool 10c, arranged on a handle housing 14c of the electrically operable power tool 10c. The electrically operable power tool 10c has a structure that is at least substantially similar to that of the electrically operable power tool 10a from FIG. 1. Reference may therefore be made, at least substantially, to the description of FIG. 1 in respect of a description, or features, of the electrically operable power tool 10c of the further exemplary embodiment. The electrically operable power tool 10c is likewise realized as a portable power tool 10c, which is constituted by an electrically operable angle grinder 12c.

The operating element 18c is arranged on a side 20c of the handle housing 14c that faces toward an inner surface of an operator's hand when the handle housing 14c is gripped for proper manipulation. In this case, the operating element 18c is mounted in a translationally movable manner on the handle housing 14c. A movement axis 40c of the operating element 18c runs at least substantially transversely in relation to a direction of longitudinal extent of the handle housing 14c. In addition, the movement axis 40c of the operating element 18c extends in a joint plane of the handle housing 14c. The operating element 18c is mounted on two sides. In this case, a guide bearing element (not represented in greater detail here) of the switching unit 16c is arranged at an end 36c of the operating element 18c that faces toward a connecting region 34c of the handle housing 14c. In addition, a further guide bearing element (not represented in greater detail here) of the switching unit 16c is arranged at an end 38c of the operating element 18c that faces away from the connecting region 34c of the handle housing 14c. It is also conceivable, however, for the operating element 18c to be movably mounted, or guided, on the handle housing 14c in another manner, considered appropriate by persons skilled in the art. The movement axis 40c is constituted by the guide bearing element. A further movement axis 92c of the operating element 18c is constituted by the further guide bearing element. In this case, the guide bearing element and the further guide bearing element may be realized as linear guide elements or as joint guide elements, which enable the operating element 18c to move translationally.

When the operating element 18c is in an unactuated state, an operating surface 32c of the operating element 18c, as viewed along a direction that is at least substantially perpendicular to an outer surface 42c of the handle housing 14c, out from an interior of the handle housing 14c that is enclosed by the handle housing 14c, extends beyond the outer surface 42b, in a direction away from the handle housing 14c. In addition, after an actuation of the operating element 18c, the operating surface 32c of the operating element 18c is, at least partially, at least substantially flush with the outer surface 42c of the handle housing 14c. Thus, as a result of an actuation in the direction of the handle housing 14c, the operating element 18c is moved along the movement axis 40c, into the handle housing 14c.

1. An electrically operable power tool, comprising:
at least one handle housing; and
at least one switching unit, which has at least one operating element mounted on a side of the at least one handle housing that faces toward an inner surface of an operator's hand, when the at least one handle housing is gripped for proper manipulation.

2. The electrically operable power tool as claimed in claim 1, further comprising at least one output housing (22), wherein the at least one operating element, in each operating state, is positioned on a side of the at least one handle housing that is different from a further side of the at least one handle housing that faces toward an output side of the at least one output housing.

3. The electrically operable power tool as claimed in claim 1, wherein the at least one operating element is mounted so as to be pivotable about a pivot axis that is located outside of an operating surface region of the at least one operating element.

4. The electrically operable power tool as claimed in claim 3, wherein the pivot axis, as viewed along a direction of longitudinal extent of the at least one operating element, is spaced apart relative to an operating surface of the at least one operating element.

5. The electrically operable power tool as claimed in claim 3, wherein the pivot axis is located at an end of the at least one operating element that faces toward a connecting region of the at least one handle housing.

6. The electrically operable power tool as claimed in claim 3, wherein the pivot axis is located at an end of the at least one operating element that faces away from a connecting region of the at least one handle housing.

7. The electrically operable power tool at least as claimed in claim 1, wherein the at least one operating element is mounted in a translationally movable manner.

8. The electrically operable power tool as claimed in claim 7, wherein a movement axis of the at least one operating element runs at least substantially transversely in relation to a direction of longitudinal extent of the at least one handle housing.

9. The electrically operable power tool as claimed in claim 1, wherein the at least one operating element is configured such that after an actuation, an operating surface of the at least one operating element is at least substantially flush with an outer surface of the at least one handle housing.

10. The electrically operable power tool as claimed in claim 1, further comprising at least one switch-on inhibitor unit, configured to avoid a movement of the at least one operating element resulting from an unintentional actuation of the at least one operating element.

11. The electrically operable power tool as claimed in claim 10, wherein the switch-on inhibitor unit has at least one release element, which comprises an actuating region that is located, at least partially, laterally next to an operating surface of the at least one operating element.

12. The electrically operable power tool as claimed in claim 1, wherein the at least one operating element has a maximum longitudinal extent that corresponds to at least 60% of a maximum longitudinal extent of a stem-type grip region of the at least one handle housing.

13. The electrically operable power tool as claimed in claim 1, wherein the at least one operating element has a maximum transverse extent that corresponds to at least 60% of a maximum transverse extent of a stem-type grip region of the at least one handle housing.

14. A power tool switching device of a power tool that has at least one handle housing, the power tool switching device comprising at least one switching unit which has at least one operating element configured to be mounted on a side of the at least one handle housing that faces toward an inner surface of an operator's hand, when the at least one handle housing is gripped for proper manipulation.
